(19) United States
(12) Patent Application Publication
(10) Pub. No.: US 2017/0110013 A1
(43) Pub. Date: Apr. 20, 2017

(54) SYSTEM AND METHOD FOR SENSOR POSITIONING AND VEHICLE TRACKING USING LPR BASED SPATIAL CONSTRAINTS

(71) Applicant: AGT INTERNATIONAL GMBH, Zurich (CH)

(72) Inventors: Nikolaos FRANGIADAKIS, Darmstadt (DE); Roel HEREMANS, Darmstadt (DE)

(73) Assignee: AGT INTERNATIONAL GMBH, Zurich (CH)

(21) Appl. No.: 15/311,062

(22) PCT Filed: Jul. 30, 2015
(86) PCT No.: PCT/EP2015/067565

§ 371 Date: Nov. 14, 2016

Related U.S. Application Data
(60) Provisional application No. 62/031,613, filed on Jul. 31, 2014.

(51) Int. Cl. G08G 1/00; G06K 9/32; G08G 1/017

(52) U.S. Cl. CPC G08G 1/205; G08G 1/0175; G06K 9/325

(57) ABSTRACT

The invention provides methods and systems for identifying objects transitioning boundaries defined around geographic areas using sensors. Objects that are vehicles are detected by license plate reader sensors. Boundaries defining geographic zones and sub-zones are pre-defined graphically by reference to a map or computed based on locations of sensors located within the geographic region. When sensor coverage is incomplete, soft zones are computed and defined. Soft zones are computed using probabilistic models, and are developed to minimize the number of escape paths from any sub-zone around sensor locations. Using these probabilistic models, additional sensors can be optimally placed for further enhancement of the detection system.

### FIELD OF THE INVENTION

The invention relates generally to systems and methods for tracking objects. Specifically, the invention relates to surveillance and tracking of a vehicle by using sensors and spatial positioning, for example, license plate recognition (LPR) sensors at known locations.

### BACKGROUND OF THE INVENTION

Geographical regions, for example cities, may have license plate recognition (LPR) or LPR gates installed throughout such regions. These LPR gates may be used to identify a vehicle that passes through such a gate. Zones may be identified by the spatial location of these gates. Information may only be passed to monitoring systems about a vehicle at the time an LPR gate actually reads a corresponding license plate. Cameras and LPRs are expensive, so not all streets may be equipped with LPRs.

### SUMMARY OF THE INVENTION

An embodiment of the system is an approach for object tracking. It allows for tracking independent of the time which elapsed since an incident occurred. One embodiment may be based on a graph of an area where the system can identify fully covered zones, e.g. 100% or near 100% sensor coverage of all possible gateways into and out from such a zone. Another embodiment may use “soft” zones that may be zones with incomplete sensor coverage. A new graph can be generated for any non-covered routes and shortest paths may be determined to many or all possible destinations. Another embodiment may use probabilistic functions to assess alternative paths. Another embodiment reverses the approach to allow for optimized sensor deployment to improve coverage by placing one or more sensors at strategically relevant locations. Some embodiments of the invention may comprise a transitory or non-transitory computer readable medium comprising instructions which when implemented in one or more processors in a computing system operably connected to sensors cause the system to implement a method for object tracking.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts an exemplary diagram illustrating components according to embodiments of the present invention;

FIG. 2 depicts an exemplary diagram according to embodiments of the present invention;

FIG. 3 depicts an exemplary block diagram according to embodiments of the present invention;

FIG. 4 depicts an exemplary method according to embodiments of the present invention; and

FIG. 5 depicts an exemplary method according to embodiments of the present invention.

Embodiments of the invention are illustrated by way of example and not limitation in the figures of the accompanying drawings, in which like reference numerals indicate corresponding, analogous or similar elements. It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

An incident may occur involving an object, or vehicle, within a geographic region. Sensors can be located around and throughout a geographic region. The geographic region can be divided into sub-regions, or sub-zones, based on a map of the region, the location of the sensors, a combination of both or another method. A vehicle may transition among sub-zones by egress from a sub-zone where an incident occurred and ingress to another sub-zone, or by departing the geographic region. When a vehicle transitions among sub-zones sensors detect the vehicle and its transition location may be determined. Determination of a location of a vehicle may be when a vehicle leaves a sub-zone, for example it may be located when it transitions from one sub-zone to another sub-zone. Although the incident occurred at a specific time, the object transitions can be tracked independent of the incident time.

A geographic region, such as a city, can be divided into sub-zones by a variety of methods. Sub-zones may be determined as, for example maximal sets of locations where all routes of egress from them may pass by at least one sensor. Therefore, vehicles leaving each sub-zone may be detected, identified and/or located. Locations of sensors and routes of travel within a geographic region to be divided into sub-zones may be used to define boundaries of sub-zones. Boundary locations may be optimized by maximizing the number of egress routes from each sub-zone where a vehicle using such route must pass by a detection sensor.

Certain geographic regions may not have sufficient sensors to ensure a vehicle exiting a sub-zone may pass through a sensor detection range, with any configuration of sub-zone definition. In such cases soft zones may be defined. Soft zones may be determined based on one or more probabilistic models or functions. Soft zones may be determined as sets of locations where all routes of egress may not necessarily pass by a sensor, however, vehicles leaving each sub-zone may be detected, identified and/or located, and may be with respect to assumptions about the escaping vehicle. Such assumptions may be probabilistic. Assumptions may include, for example, that the vehicle may escape by routes that may be sub-optimal in some respects, for example according to distance. Alternatively, according to a probability, vehicles may reach another soft zone, possibly within the same sub-zone.

Reversing these analyses and approaches, the same methods may be used to analyze sensor coverage of an area. Such analysis may indicate potential locations of sensors to improve coverage. Using such a method, sensors may be placed most efficiently. Eventually sensors may be placed according to such analyses to provide complete coverage of an entire geographic region.

Streets of a city may be provisioned with cameras, License Plate Recognition (LPR's) devices, etc., to allow continuously tracing a vehicle's movements. For example, if an event occurs in a particular location, such that the driver wants to get away, e.g., a hit-and-run accident, no matter which street such driver takes for an exit they are each covered by one or more LPR's, and thus the police, or operator of the LPR, can identify the car and driver after the incident. Other scenarios may involve object tracking, in addition to vehicles. Cameras and LPR's are expensive, so not all streets may be provisioned. In such a case a goal may be to allow a limited number of cameras/LPR's to be optimally distributed to get the best, or optimum, non-total coverage. A criterion may be that the probability that a driver will evade being detected, for example by escaping exclusively via streets without a camera and/or LPR, may be below a predetermined threshold probability. Embodiments provide a way of doing this. A method may include the step of physically installing a device in a specific location derived according to the previous steps of a method of an embodiment. A probability may be characterized by, for example, a number of escape routes divided by a total number of streets within a geographic area or city. Another example of such probability may be a number of escape routes multiplied by a second probability of taking each such route, and divided by a total number of streets within a geographic area or city, and such second probability of taking each such route may depend on a variety of factors, e.g. assumptions about the vehicle.

Other embodiments consider the issue of how data from cameras and/or LPR's may be analyzed to determine which of the vehicles detected on a getaway path was the perpetrator of the incident.

An embodiment of a system may subdivide a representation of a spatial area into sub-zones. Sub-zones may be of different types. There may be sub-zones which may be completely covered by sensors such that an object cannot escape from a sub-zone without passing a respective sensor gate. That is, as long as the object is not detected by any one of the sub-zone gates the object may still be within the sub-zone. This method allows for focus on potential gates when selecting sensors for tracking an object. For example, if a gate is passed by an object and the object transitions into another sub-zone the system may know which sensors need to be activated because the system can immediately identify relevant gates of the new sub-zone. In some embodiments, a sub-zone may not be completely covered with sensors at all possible escape gateways or routes of egress and a probabilistic approach may be used, for example in a case where a soft-zone may be present. In some embodiments, one or more boundaries may be identified by other means, e.g. other sensors, other sensor types, other monitoring such as monitoring by officials or police personnel, etc. Some boundaries may be assumed to be secure boundaries. In such a case, the system may eliminate all edges from a graph which may be covered with sensors. A new graph may be generated which may include all possible routes to all possible destinations which might be used by an escaping object without being caught by a sensor. For each possible destination the system may now calculate alternative paths to respective destinations and may evaluate paths with regard to respective transition times. For example, if one path takes 6 times as long as a shortest path it may be disregarded and not be considered as a potential “soft” zone. The system may now calculate pairs of shortest paths for all possible destinations, and may also calculate alternative pairs with a certain probability that they might be used. Such probability may be quantified by a variety of methods, for example as described herein.

When reversing such an approach this embodiment of a method may be used to analyze sensor coverage of an area and identify locations for sensor deployment that may improve coverage by placing sensors to cover soft zones, and may convert them into 100% covered zones in the future.

A boundary crossing event detection system may contain one or more means for construction of a model, and may create or develop model zone data and/or model subzone data. The boundary crossing event detection system may furthermore contain position sensing means for sensing current position. The boundary crossing event detection system may furthermore comprise position comparison means for determining when the sensed position is within model zones and model subzones. The boundary crossing event detection system may furthermore contain boundary crossing event detection means for detecting movement between model subzones. Embodiments introduce a zone/sub-zone concept and may be directed to the detection of boundary crossing, for example, acquiring an ability to detect if a given car has crossed a certain boundary. This can be of interest for two different regions with, for example, different tax rates.

Embodiments use Soft Zones to confine even unbounded areas, to provide an algorithm, or an online algorithm, to “softly” compute Soft Zones, e.g. given an initial area. Street map information may be exploited together with a priori knowledge about geographical boundary locations to reduce the search space, e.g. a number of LPR gates to review. Embodiments use methods to compute critical escape paths and optimal boundary placement.

An advantage of an embodiment may be the pre-computational, e.g. off-line, aspect of a method. For example, previously, a system would be able to optimally detect escaping cars that were considered a priori to be driving. When the car would stop for a certain time a search area would grow until an entire city would be covered. In an embodiment, an algorithm serves as an additional improvement, where when the time exceeds a certain threshold value in which the suspected vehicle has not been detected, the algorithm switches to a second option where an assumption may be made, for example that the suspected car stopped driving. In such a case this approach may still tell the operator which LPR gates need to be supervised in order to catch the vehicle, for example in the case where it starts driving around again.

Identification of escape or egress from confines and/or boundaries, for example license plate reader (LPR) gate positions, of objects, e.g. vehicles, from a given geographical location is addressed. Such an approach may be implemented within a given geographical region, e.g. a city, and the objects may be considered to be vehicles. A location of an event, e.g. a conflict, of interest may be known, and the system may then be able to define a subset of LPR gates enclosing a connected component region associated with the conflict location. The system provides a solution which may be completely disentangled from the time of the conflict. For example, following a duration of time after the time of the incident, the vehicle may move outside the connected component region associated with a location of the conflict. As such, the number of LPR gates used to verify or locate the suspicious vehicle may be drastically reduced.

Escape confines can be used to construct such a system. Zones may be completely identified and/or enclosed by escape confines. Soft zones may be identified, e.g. defined by a mathematical description. Such soft zones may help with solving, for example, a problem in a case of large zones, e.g. when there may not be any LPR gates, or on small roads. In a case of an event occurrence, zone(s) and/or soft zone(s) that enclose an event area may be identified. Objects inside an area of interest may be separated from other objects within the area, and such separation may occur concurrently or following an event. Given an area, locations may be optimized where boundaries may be placed, for example to better confine such area. Also, given an area and a set of already placed boundaries, critical escape paths may be identified. Critical locations that may result in significantly increased soft zone areas may be identified, given an area and a set of previously placed boundaries. An optimal placement of such boundaries may be based on the cost for placing boundaries at possible new locations and/or a budget, where a set of already placed boundaries and/or an area may be previously determined. In some embodiments, the probability of a boundary being effective may be less than 100%. In such cases, the probable areas and/or set of users may be estimated, and may provide, for example, locations for boundaries based on a probabilistic model or result.

An embodiment may produce a list of LPR locations where vehicles may eventually pass by when they are moving around. Such a list of LPR locations may depend on an initial interest zone, for example of a given conflict.

Embodiments may propose a notion of Soft Zones to confine even unbounded areas and to provide an online algorithm to softly compute Soft Zones, e.g. given an initial geographic area. Street map information may be used together with a priori knowledge about geographical boundary locations to reduce the search space, e.g. a number of LPR gates to look in or focus upon. Methods to compute critical escape paths and optimal boundary placement are described by other embodiments.

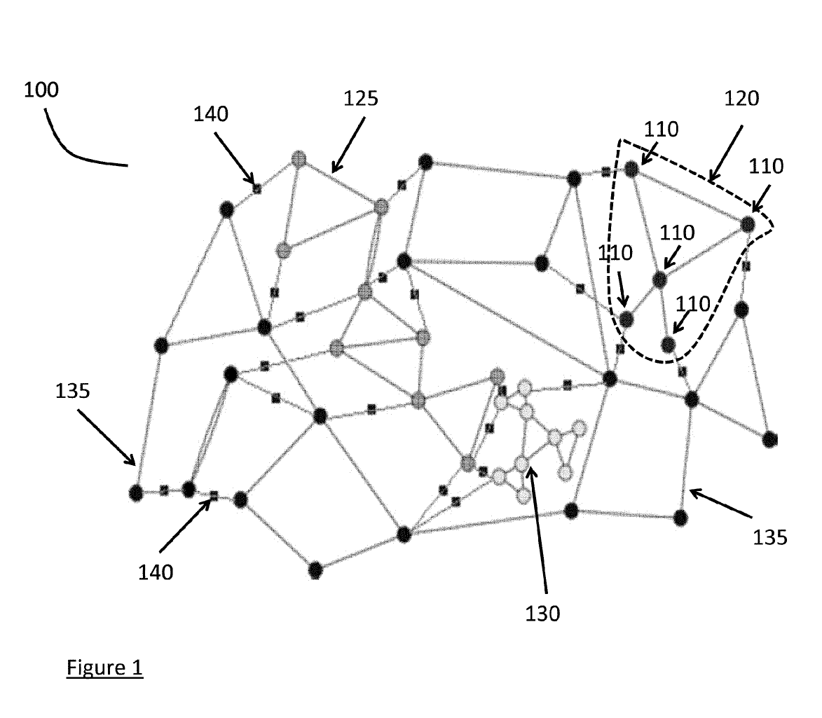

Reference is made to FIG. 1, which is an exemplary diagram illustrating components according to an embodiment of the present invention. FIG. 1 may represent a geographic region 100 that may have been sub-divided into subzones 120, 125, 130 and 135. In an embodiment, a street map, e.g. of a city of deployment, or other geographic region, and a list of substantially all locations of license plate reader (LPR) locations, or gates, may be used in a pre-calculation step, e.g. based on the theory of connected components, may be able to subdivide the city's spatial area into one or more subzones, e.g. sub-zone 120 of FIG. 1, or connected nodes of the same shading of FIG. 1. A union of all the subzones may represent the entire city, and each individual subzone may represent an area in the city wherein a vehicle can move around without passing an LPR gate. Leaving, or egress from, a subzone means that a car has to pass at least one LPR gate. Using such a pre-calculation, a user of the system may focus on relevant LPR gates only. A method according to an embodiment may be completely disentangled from any time limit in which the suspect and/or vehicle may leave the region in which it became suspicious. A car may move around at a point in time, and may eventually leave the subzone and be detected by an LPR camera which it may have passed.

Nodes 110 within geographic region 100 may be allocated together to form a zone, or sub-zone 120. Sub-zone 120 may be defined by a subset from all nodes in region 100, that may be freely moved among without passing by a sensor, here denoted by a small square 140. Once a path between nodes 110 transits by a sensor 140, a boundary of sub-zone 120 is identified. Multiple sub-zones 120, 125, 130 and 135 may be defined, and may be pre-determined.

Sensors 140 may be spatially located, e.g. at fixed positions, within geographic area 100. Sensors 140 may be any sensor being used according to embodiments of the present invention, e.g. a license plate recognition (LPR), license plate detection device, facial recognition device, other vehicle detection device, other object detection device, etc. Sensors 140 may be at pre-determined locations. In some embodiments sensors 140 may have locations of each determined, for example for optimal placement in order to optimize sub-zones or sub-zones definition.

Geographic region 100 may be any geographic region where surveillance of objects may be desired. For example, geographic region 100 may be a city, e.g. bound by city limits. Geographic region 100 may also be any region where surveillance of objects is in progress and additional methods according to embodiments of the present invention are to be applied. Geographic region 100 may be a region defined by reference to a map or any other geo-spatial reference tool.

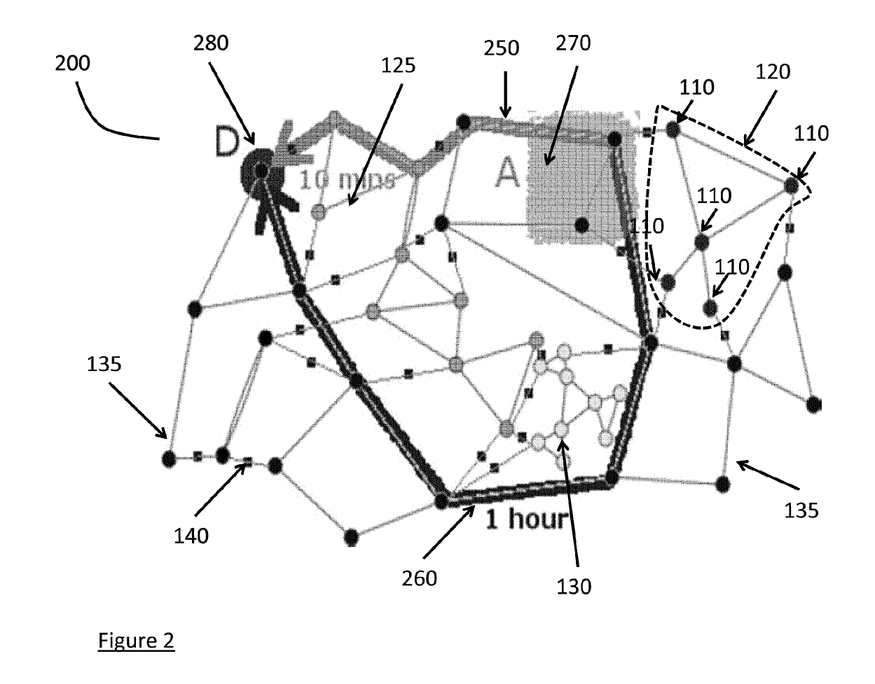

Reference is made to FIG. 2, which is an exemplary diagram illustrating components according to an embodiment of the present invention. FIG. 2 may represent a geographic region 200 that may have been sub-divided into subzones 120, 125, 130 and 135. An embodiment may be calculated entirely off-line and a result may be considered to be non-probabilistic when it may be assumed that LPR gate detection is substantially 100% efficient. A variation to such an embodiment may lead to a probabilistic solution, e.g. as depicted by FIG. 2, and may define a soft zone. In such an embodiment, all pair shortest paths may be calculated within a given subset of nodes and may be compared against an all pair shortest path on the full graph, e.g. all pair shortest path 250. For example, consider one pair starting at node A 270 and arriving at node D 280. For a cost on the full graph, C_{Full}, for example, it may take 10 minutes to cross the distance. To go from A 270 to D 280 on the graph via path 260, the time and cost C_{(LPR)} may be considerably longer, e.g. a cost of 1 hour, due to perhaps a longer distance. By constructing a subset based on an additional parameter α it may be possible to allow trajectory 260 to be included in a search region. Note that by definition it may be C_{(LPR)}(A,N_{id})≧C_{Full}(A,N_{id}). The following mathematical expression for the search region may be used:

Nodes in soft area of set Area A 270 are the set of nodes N_{id} such that

{N_{id} in SubGraph: N_{id} is connected to A 270 with cost αεIR between 0 and 1 & α C_{—(LPR)} (A,N_{id})<C_{Full} (A,N_{id})}.

The parameter β=1−α may be considered a probability to allow a path that is β times longer than the shortest path between area A 270 and location D 280.

Geographic region 200 may be any geographic region where surveillance of objects may be desired. Geographic region 200 may be defined according to geographic region 100. Geographic region 200 may be defined without reference to specific geographic limits, and may be regionally defined.

Another embodiment may be another extension to a connected component approach, for example, a city authority may decide to invest in n additional LPR gates. An embodiment may be used to find what the most optimal placements would be for those gates. A technique may optimize the LPR locations by maximizing the number of subzones with minimal area coverage. When a city authority may have an indication, for example, that a particular region in the city may be more prone to accidents, the problem may use a multiple objective approach, taking the respective factors into account.

Another embodiment may use soft zones, and may relate to the computer science domain of approximations, where an alpha is used in cases where it may be hard to find an exact solution. Embodiments do not necessarily try to approximate a solution, since, for example, a solution may not exist. As an alternative, embodiments relax the problem and/or constraints. Approximations may be solved, e.g. for similar problems, but a notion of an approximate zone may be defined differently, and may solve irrelevant cases. Soft zones may be defined in a way that allows deduction of practical and useful information about which users and/or vehicles may be present at a location based on special constraints, e.g. spatial constraints.

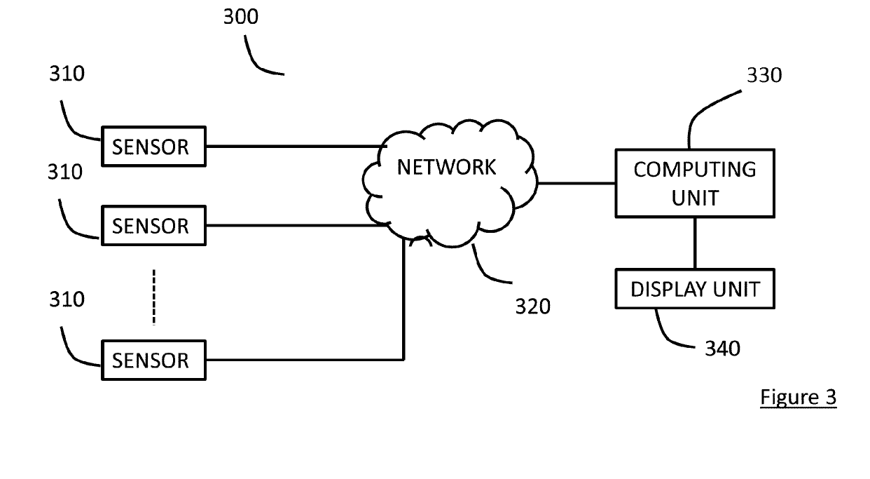

Reference is made to FIG. 3, which is an exemplary block diagram 300 according to embodiments of the present invention. One or more sensors 310 may be geo-spatially located among a geographic region 100 or 200. Sensors 310 may be substantially similar to sensors 140. Sensors 310 may be operably connected to network 320, and may have ability of two-way communication or one-way from sensor 310 to network 320. Communication between sensors 310 and network 320 may be, for example by wired connection, by wireless connection, via an intermediary element or by any other operable connection. Communication between sensors 310 and network 320 may be real time or by storage and later transmission of information. Sensors 310 may also be detection devices.

Computing unit 330 may be any suitable computer or computing device. Computing unit 330 may be used to execute any computations according to embodiments of the present invention. Computing unit 330 may be a stand-alone computing device or may be contained within other computing or multi-functional devices. Computing unit 330 may be comprised of one or more processors that may be configured to perform according to instructions from a computer readable medium. Computing unit 330 may be operably connected to sensors 310 and network 320, where such connection may be wired, wireless or any other operably connection.

Display unit 340 may be operably connected to computing unit 330, network 320 and sensors 310. Display unit 340 may be configured to display to a user of a system according to embodiments of the present invention any outputs or alerts that such system may generate. Display unit 340 may also be used by a user to input commands, directions or selections into a system according to embodiments of the present invention. Any alert that an object or vehicle may be transitioning a sub-zone boundary may be provided via display unit 340. Display unit 340 and computing unit 330 may form part of the same device or may be separate operably connected devices.

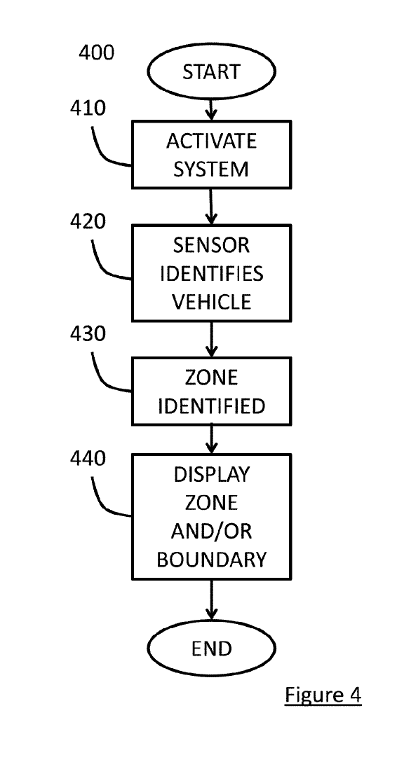

Reference is made to FIG. 4, which is an exemplary method 400 for locating a vehicle according to embodiments of the present invention. A process begins and a system is activated 410. A sensor may identify a vehicle 420. Sensors may be license plate readers or any other suitable sensors. A vehicle may be located according to a particular sensor that may have been activated and its geo-spatial location. A zone where such a vehicle may be located may be identified 430, for example by using information provided by a sensor and the location of that sensor. A zone and/or a boundary, e.g. of such a zone, may be displayed to a user of the system.

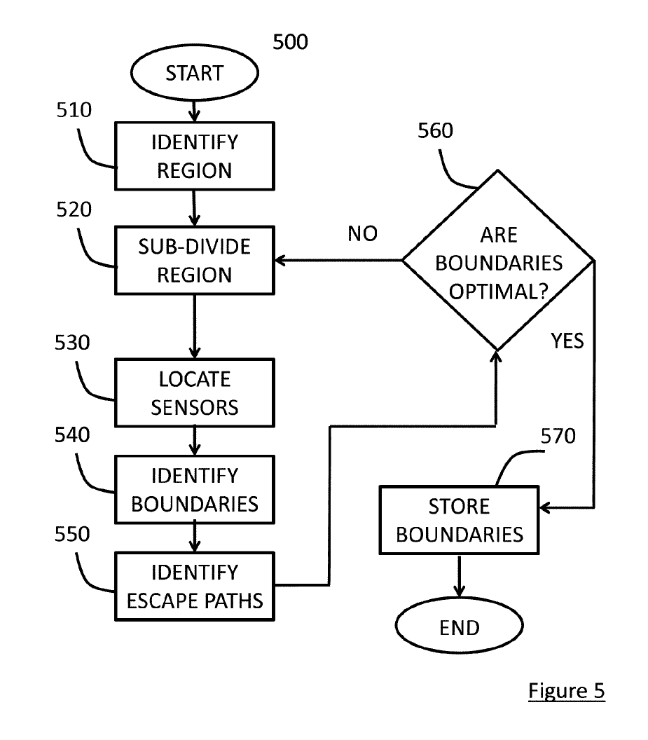

Reference is made to FIG. 5, which is an exemplary method 500 for defining sub-zones according to embodiments of the present invention. A process begins and a region, e.g. a geographic region, is identified 510. Sub-zones may be determined by sub-dividing a pre-determined geographical area 520, e.g. a city, into sub-areas, or sub-zones, which may each be enclosed by boundaries. Such subdivision may be based on a map and/or a priori knowledge of geographic boundaries. Locations of sensors may be identified 530 within and/or throughout the geographical area. Boundaries may be defined and/or identified 540 relative to locations of sensors which may be within each boundary. Paths of egress, or escape paths, across such boundaries may be identified 550 and analyzed to determine which sensors may be along these paths. Critical escape paths may be computed from paths of egress. Boundaries may be selected or found by an algorithm. It may be optimal to select boundaries that have a maximum number of egress paths from an enclosed sub-zone that pass by one or more sensors. In some cases one sensor would be sufficient, and in other cases multiple sensors may be used. Sub-zones may be defined by areas that may be enclosed by such optimally selected boundaries. A determination may be made whether boundaries may be optimal 560. Should a determination be made that boundaries selected may be less than optimal, a geographic region may be sub-divided again 520 using different subdivisions. Once defined, sub-zone boundaries and/or locations may be stored 570 for future use or reference.

Sensors may be license plate readers or other suitable vehicle or object detection devices. Sub-zones may be pre-selected or pre-determined, for example by a user. Paths of egress from any sub-zone may be considered to be escape paths, for example when referring to a person or vehicle.

In some embodiments, a determination may be made to add additional detection devices, and optimal placement of such additional devices may be computed. Optimal placement of each such additional detection device may be determined by maximizing a number of sub-zones and/or minimizing the area coverage of each sub-zone.

In some embodiments boundaries of sub-zones may be determined probabilistically. Such sub-zones may be referred to as soft zones, and may be defined by or based on probabilistic models. Soft zones may be used to confine any area, including areas that may have been previously unbounded, where unbounded may mean by such a system or method as described herein. Soft zones may be computed using an algorithm based on a pre-determined initial area, or an area selected by a user. When computing soft zones using an algorithm based on a pre-determined initial area and/or probabilistically such soft zones are said to be softly computed. Pre-determining an area, or other determinations, may be performed locally, remotely, online, offline or by any other suitable method.

An advantage of embodiments of the present invention may be the pre-computational, e.g. off-line, aspect of such a method. Other approaches may be designed to be able to optimally detect escaping cars that were considered a priori to be driving. When a car would stop for a certain time such systems' search area would keep growing until, for example, an entire city would be covered. In some embodiments the algorithm may serve as an additional improvement to such other systems. An added value may be that when a time exceeds a certain threshold value in which a suspected vehicle may not have been detected that the algorithm may switch to a second option where an assumption may be made that the suspected car stopped driving. In such a case this approach will still tell the operator which LPR gates need to be supervised in order to catch the vehicle in case it may start driving around again.

In an embodiment, for example, one that may be used for illustration reasons herein, a graph may be split into hard zones using a variety of methods, e.g. a Connected Components algorithm, where a hard zone may be determined deterministically. An implementation of such an algorithm may be provided, e.g. from the Library of Efficient Models and Optimization in Networks (LEMON) C++ library, where the graphs of pictures may be found. There may also be a number of very soft algorithms for connected components. In a directed case, respective strongly connected components algorithms may be relevant.

In some embodiments, for pre-computation of computing soft zones, an index may be built using all-pairs shortest paths. Such a method may be used, for example, where a large network of LPR gates may be in place and from which an associated street map may be available. Such a method may be used in combination with other methods to find objects in an efficient manner with a minimal amount of used resources. Such an index may be used in soft zone computations.

Applications of embodiments may be any enterprise involved in traffic surveillance. Changing vehicles by humans and/or LPR gates using face recognition tools are other applications where embodiments may be used to find humans, for example in a city street network

Some embodiments may comprise a method for tracking by sensing objects, where a signal may be produced by one or more spatially disparate sensors when sensing an object, and such sensors may be positioned to form a pre-determined boundary. Such sensors may transmit a signal across a network from one or more sensors to a control unit, or a computing unit that may comprise a control unit. An alert may be produced corresponding to one or more sensors by a user interface operably connected to a control unit when the control unit receives the transmitted signal. Objects may be vehicles, sensors may be license plate detection and/or reading devices, and a user interface may display a list according to a boundary of license plate reading device locations that sensed a vehicle. A user interface may comprise a display unit and/or an input device. A pre-determined boundary may comprise a subset of a pre-determined geographic region and such pre-determined boundary may define a zone. A pre-determined boundary may comprises a plurality of pre-determined boundaries, each subdividing a pre-determined geographic region into sub-zones, and in total comprising substantially all of a pre-determined geographic region.

An object passing across a boundary of said sub-zone may be sensed, and boundaries of sub-zones may be associated with license plate readers. One or more sub-zones may be pre-determined by a user through a user interface. An alert may be produced at an independent time after, and relative to, sensing.

Some embodiments may be a method for pre-determining sub-zone boundaries comprising subdividing a pre-determined geographical area into one or more sub-areas each enclosed by boundaries, identifying locations of a plurality of detection devices within a pre-determined geographical area, defining boundaries relative to locations of detection devices, identifying paths of egress from each sub-area enclosed by a corresponding boundary, analyzing paths of egress to determine a number of detection devices along each path, determining whether such boundaries may be optimally selected by maximizing the number of paths of egress that include at least one detection device, and determining sub-zones as sub-areas enclosed by optimally selected boundaries. Detection devices may be license plate detection and reading devices. Selected sub-zones and optimally selected boundaries may be stored for future use or reference. One or more sub-zones may be pre-determined by a user. Sub-zones may be defined by one or more probabilistic models to be soft zones, and such boundaries may be determined by one or more probabilistic models. Such probabilistic models may be derived from either probabilistic assumptions about an escaping object travelling along a paths of egress, or from probabilistic assumptions about the behavior or movement pattern of an object travelling along a paths of egress.

An embodiment may comprise defining one or more nodes each as a location within a sub-zone, calculating all pair-shortest paths between such nodes within a sub-zone, calculating all pair-shortest paths within a pre-determined geographical area, comparing all pair-shortest paths within a sub-zone to all pair-shortest paths within a pre-determined geographical area, and using a comparison to determine optimal boundaries for the soft zones. Such a comparison may be a time or cost comparison, or any other suitable comparison. Soft zones may confine previously unbounded areas, or areas unable to be bounded by deterministic zones or methods. Soft zones may be computed using an algorithm based on a pre-determined initial area. Subdividing may be based on a map and/or a priori knowledge of geographical boundaries. Defining sub-zones may be pre-computed or performed offline. Additional detection devices may be added by computing an optimal placement of each additional detection device, where optimal placement of each such additional detection device may be determined by maximizing the number of sub-zones and minimizing the area coverage of each sub-zone.

Some embodiments may be a system for tracking by sensing objects comprising a plurality of operably connected spatially disparate sensors positioned to form a pre-determined boundary, each such sensor producing a signal when sensing an object transitioning a pre-determined boundary, a network controlled by a computing unit, or control unit, for transitioning signals among operably connected devices, and operably connected to said sensors; and a user interface unit operably connected to the network for producing an alert corresponding to receiving by a computing unit of a signal produced by each a sensor. Signals may be from one or more sensors. A display unit may be part of a user interface unit. Objects may be vehicles, sensors may be license plate detection and reading devices, a user interface may display a list of license plate detection and reading device locations that sensed a vehicle, and such a list may be displayed based on an identification of a boundary. Such a boundary may be a subset of a pre-determined geographic region. A boundary may define a zone. A boundary may comprise a plurality of boundaries, each subdividing a pre-determined geographic region, and in total comprising substantially all of a region, and a plurality of boundaries subdivide a geographic region into sub-zones. A geographic region may be a city. Boundaries of sub-zones may be associated with license plate readers. An object passing across said sub-zone boundary may be sensed. An object may be a vehicle.

One or more sub-zones may be pre-determined by a user. An alert may be produced at an independent time after, and relative to, sensing. A priori knowledge of geographic boundaries may be used to reduce the search space. A number of sensors examined may be reduced and may depend on zone definitions. An alert may be produced when a plurality of boundaries may be transitioned. Regions encompassed by pre-selected boundaries may be excluded, and such exclusion may be a multiple objective approach, or according to any other suitable approach. Boundaries may be determined probabilistically. Sub-zones may be soft zones. Boundaries may encompas zones or sub-zones, and such sub-zones may be defined by one or more probabilistic models to be soft zones.

Some embodiments may comprising defining one or more nodes each as a location within a sub-zone, calculating all pair-shortest paths between such nodes within a sub-zone, calculating all pair-shortest paths within a pre-determined geographical area, comparing all pair-shortest paths within a sub-zone to all pair-shortest paths within a pre-determined geographical area, and using such a comparison to determine optimal boundaries for soft zones. Soft zones may be computed using an algorithm based on a pre-determined initial area. Computing soft zones by using an algorithm based on a pre-determined initial area may be referred to as softly computed. Determinations that may be made may be performed online or remotely. Subdividing may be based on a map and/or a priori knowledge of geographical boundaries.

Another embodiment may use pre-determined constraints to identify users present at or near a location associated with a soft zone.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method for tracking by sensing objects comprising:
producing a signal by one or more spatially disparate sensors when sensing an object, wherein said sensors are positioned to form a pre-determined boundary;
transmitting said signal across a network from said one or more sensors to a control unit; and
producing an alert corresponding to said one or more sensors by a user interface operably connected to said control unit when said control unit receives said transmitted signal.

2. The method of claim 1, wherein said objects are vehicles, said sensors are license plate detection and reading devices, and said user interface displays a list according to said boundary of said license plate reading device locations that sensed said vehicle.

3. The method of claim 1, wherein said pre-determined boundary comprises a subset of a pre-determined geographic region and said pre-determined boundary defines a zone.

4. The method of claim 1, wherein said pre-determined boundary comprises a plurality of pre-determined boundaries, each subdividing a pre-determined geographic region into sub-zones, and in total comprising substantially all of said pre-determined geographic region.

5. The method of claim 4, further comprising sensing an object passing across a boundary of said sub-zone, and said boundaries of said sub-zones are associated with said license plate readers.

6. The method of claim 5, wherein one or more sub-zones are pre-determined by a user through said user interface.

7. The method of claim 1, further comprising producing said alert at an independent time after, and relative to, said sensing.

8. A method for pre-determining sub-zone boundaries comprising:
subdividing a pre-determined geographical area into one or more sub-areas each enclosed by boundaries;
identifying locations of a plurality of detection devices within said pre-determined geographical area;
defining said boundaries relative to said locations of said detection devices;
identifying paths of egress from each said sub-area enclosed by a corresponding said boundary;
analyzing said paths of egress to determine a number of detection devices along each path;
determining whether said boundaries are optimally selected by maximizing the number of said paths of egress that include at least one detection device; and
determining sub-zones as sub-areas enclosed by optimally selected boundaries.

9. The method of claim 8, wherein said sub-zones are defined by one or more probabilistic models to be soft zones, and said boundaries are determined by one or more probabilistic models.

10. The method of claim 9, wherein said probabilistic models are derived from either probabilistic assumptions about an escaping object travelling along one of said paths of egress, or from probabilistic assumptions about the behavior or movement pattern of an object travelling along one of said paths of egress.

11. The method of claim 9, further comprising: defining one or more nodes each as a location within a sub-zone; calculating all pair-shortest paths between said nodes within said sub-zone; calculating all pair-shortest paths within said pre-determined geographical area; comparing all pair-shortest paths within said sub-zone to all pair-shortest paths within said pre-determined geographical area; and using said comparison to determine optimal boundaries for said soft zones.

12. The method of claim 8, wherein said subdividing is based on a map and/or a priori knowledge of geographical boundaries.

13. The method of claim 8, further comprising adding additional detection devices by computing the optimal placement of each said additional detection device, wherein said optimal placement of each said additional detection device is determined by maximizing the number of sub-zones and minimizing the area coverage of each sub-zone.

14. A system for tracking by sensing objects comprising:
a plurality of operably connected spatially disparate sensors positioned to form a pre-determined boundary, each said sensor producing a signal when sensing an object transitioning said pre-determined boundary;
a network controlled by a computing unit for transitioning signals among operably connected devices, and operably connected to said sensors; and
a user interface unit operably connected to said network for producing an alert corresponding to receiving by said computing unit of said signal produced by each said sensor.

15. The system of claim 14, wherein said objects are vehicles, said sensors are license plate detection and reading devices, said user interface is configured to display a list of said license plate detection and reading device locations that sensed said vehicle, said list being displayed based on an identification of said boundary.

16. The system of claim 14, wherein said boundary comprises a plurality of boundaries, each subdividing a pre-determined geographic region, and in total comprising substantially all of said region, and said plurality of boundaries subdivide said geographic region into sub-zones.

17. The system of claim 14, configured to produce said alert at an independent time after, and relative to, said sensing.

18. The system of claim 14, wherein regions encompassed by pre-selected boundaries are excluded, and said exclusion is a multiple objective approach.

19. The system of claim 14, wherein said boundaries encompass zones or sub-zones, and said sub-zones are defined by one or more probabilistic models to be soft zones.

20. The system of claim 19, configured to: define one or more nodes each as a location within a sub-zone; calculate all pair-shortest paths between said nodes within a sub-zone; calculate all pair-shortest paths within said pre-determined geographical area; compare all pair-shortest paths within a sub-zone to all pair-shortest paths within said pre-determined geographical area; and use said comparison to determine optimal boundaries for said soft zones.

21. A computer readable medium comprising instructions which when implemented in one or more processors in a computing system operably connected to sensors cause the system to implement the method of claim 1.
